(19) United States
(12) Patent Application Publication
(10) Pub. No.: US 2026/0191629 A1
(43) Pub. Date: Jul. 9, 2026

(54) CONSUMABLE EXTRUSION CONTROL SYSTEM, METHOD AND DEVICE

(71) Applicant: DIMI LIFE TECHNOLOGY CO., LTD., Shenzhen, Guangdong (CN)

(72) Inventors: Lulu HU, Shenzhen (CN); Wei HOU, Shenzhen (CN); Maotong JIANG, Shenzhen (CN); Ning LIU, Shenzhen (CN)

(73) Assignee: DIMI LIFE TECHNOLOGY CO., LTD., Shenzhen, Guangdong (CN)

(21) Appl. No.: 18/864,898

(22) PCT Filed: Oct. 27, 2023
(86) PCT No.: PCT/CN2023/127182

§ 371 Date: Nov. 12, 2024

(30) Foreign Application Priority Data
Apr. 19, 2023 (CN) 202320914657.3
Apr. 19, 2023 (CN) 202320938920.2
Apr. 19, 2023 (CN) 202320989623.0

(51) Int. Cl. A61C 17/22; A46B 13/02; A46B 13/04; B67D 3/00

(52) U.S. Cl. CPC A61C 17/227; A46B 13/023; A46B 13/04; B67D 3/0003

(57) ABSTRACT

A consumable extrusion control system, a consumable extrusion control method and a consumable extrusion control device are provided. The consumable extrusion control system includes: a main body; a plurality consumable chambers coupled to the main body through respective pipelines; a plurality of first driving assemblies arranged on the respective pipelines for the consumable chambers, and configured to provide a driving force for consumables in the consumable chambers; and a control unit arranged at the main body, and configured to control and switch a corresponding first driving assembly to operate, to deliver the consumable from a corresponding one of the consumable chambers to the main body.

### CROSS-REFERENCE TO RELATED APPLICATION

This application is the U.S. national phase of PCT Application No. PCT/CN2023/127182 filed on Oct. 27, 2023, which claims priorities of the Chinese patent application No.202320914657.3, the Chinese patent application No.202320938920.2 and the Chinese patent application No.202320989623.0 filed in China on Apr. 19, 2023, which are incorporated herein by reference in their entireties.

### TECHNICAL FIELD

The present disclosure relates to the field of personal care technology, in particular to a consumable extrusion control system, a consumable extrusion control method and a consumable extrusion control device.

### BACKGROUND

In conventional personal care products, an oral cleaning product such as electric toothbrush or oral irrigator may be used to clean a mouth, so as to reduce dental plaque and remove the other bacterium and chemical substances that harm teeth. Currently, for the market-available oral care product with a self-contained care consumable, the care consumable is extruded manually or automatically in an electric manner. However, in the known oral care product, only a single consumable can be extruded automatically, and it is impossible to extrude various care consumables, so it cannot meet the user's requirements.

### SUMMARY

An object of the present disclosure is to provide a consumable extrusion control system, a consumable extrusion control method and a consumable extrusion control device.

In a first aspect, the present disclosure provides in some embodiments a consumable extrusion control system, including: a main body; a plurality consumable chambers coupled to the main body through respective pipelines; a plurality of first driving assemblies arranged on the respective pipelines for the consumable chambers, and configured to provide a driving force for consumables in the consumable chambers; and a control unit arranged at the main body, and configured to control and switch a corresponding first driving assembly to operate, to deliver the consumable from a corresponding consumable chamber to the main body.

Optionally, the first driving assembly includes a first driving state and a second driving state, wherein the first driving assembly is configured to deliver, in the first driving state, the consumable from a target consumable chamber to the main body through a corresponding pipeline, and configured to move, in the second driving state, the consumable remaining in the pipeline back into the corresponding consumable chamber.

Optionally, the pipelines include a primary pipeline coupled to the main body and a plurality of branch pipelines, the branch pipelines couple the respective consumable chambers to the primary pipeline; the plurality of first driving assemblies is arranged on the corresponding branch pipelines, respectively; the first driving assembly is any one of a peristaltic pump, an air pump, a gear pump, a screw pump or a rotor pump.

In a second aspect, the present disclosure provides in some embodiments a consumable extrusion control system, including: a main body; a plurality consumable chambers coupled to the main body through respective pipelines; a first driving assembly coupled to the pipelines, and configured to provide a driving force for consumables in the consumable chambers; a consumable switching assembly configured to control a corresponding pipeline to be switched between an open state and a closed state; and a control unit arranged at the main body, and configured to control the consumable switching assembly and the first driving assembly to operate, to switch to deliver the consumable from a corresponding consumable chamber to the main body.

Optionally, the first driving assembly includes a first driving state and a second driving state, wherein the first driving assembly is configured to deliver, in the first driving state, the consumable from a target consumable chamber to the main body through a corresponding pipeline, and configured to move, in the second driving state, the consumable remaining in the pipeline back into the corresponding consumable chamber.

Optionally, the consumable switching assembly includes a second driving assembly and a diverter rotary disk, wherein the diverter rotary disk is coupled to the second driving assembly and adapted to the plurality of consumable chambers, the diverter rotary disk is arranged on the pipeline and provided with an opening through which the pipeline is in connection with the corresponding consumable chamber, the second driving assembly is configured to drive the diverter rotary disk to rotate, to enable a corresponding consumable chamber to be in connection with the pipeline through the opening of the diverter rotary disk.

Optionally, a consumable switching assembly includes a locking member coupled to the diverter rotary disk and configured to control the diverter rotary disk to be switched between a locking state and an unlocking state.

Optionally, the pipelines include a primary pipeline coupled to the main body and a plurality of branch pipelines, the branch pipelines couple the respective consumable chambers to the primary pipeline, the first driving assembly includes two pump heads arranged on the respective branch pipelines, a rotating shaft coupled to the two pump heads and configured to drive the two pump heads, and a first spinning motor coupled to the rotating shaft, the consumable switching assembly includes a second spinning motor coupled to the rotating shaft, the second spinning motor is configured to control and switch the rotating shaft to be coupled to or decoupled from a corresponding one of the two pump heads, and the first spinning motor is configured to drive the corresponding pump head to operate through the rotating shaft, to deliver the consumable in a corresponding branch.

Optionally, the pipelines include a primary pipeline coupled to the main body and a plurality of branch pipelines, the branch pipelines couple the respective consumable chambers to the primary pipeline. The consumable switching assembly includes: a plurality of air bags arranged on the respective branch pipelines; a pneumatic element configured to inflate the plurality of air bags; and a control switch configured to control the pneumatic element to be switched between a state where the pneumatic element is in connection with a corresponding air bag, and a state where the pneumatic element is not in connection with the corresponding air bag. The consumable switching assembly is configured to control the pneumatic element to be the in connection with, or not in connection with, the corresponding air bag through the control switch, to control the consumable chamber to be switched between a state where the consumable chamber is coupled to the corresponding branch pipeline and a state where the consumable chamber is decoupled from the corresponding branch pipeline through an inflated state or an uninflated state of the air bag.

Optionally, the pipelines include a primary pipeline coupled to the main body and a plurality of branch pipelines, the branch pipelines couple the respective consumable chambers to the primary pipeline, the consumable switching assembly includes a cam structure including a driving motor and a cam rotatably coupled to the driving motor, wherein the consumable switching assembly is configured to drive the cam to be switched between a first driving position and a second driving position through the driving motor, to control the consumable chamber to switched between a state where the consumable chamber is coupled to the corresponding branch pipeline and a state where the consumable chamber is decoupled from the corresponding branch pipeline.

Optionally, the pipelines include a primary pipeline coupled to the main body and a plurality of branch pipelines, the branch pipelines couple the respective consumable chambers to the primary pipeline; the consumable switching assembly is a controllable multi-way valve, wherein the controllable multi-way valve includes one first connection port and at least two second connection ports, the first connection port is in connection with the primary pipeline, the second connection ports are in connection with the branch pipelines respectively, the controllable multi-way valve includes a first connection state and a first non-connection state, the controllable multi-way valve is configured to, in the first connection state, couple the primary pipeline to any one of the branch pipelines, and configured to, in the first non-connection state, decouple the primary pipeline from any one of the branch pipelines, and the control unit is further configured to control the controllable multi-way valve to be switched between the first connection state and the first non-connection state.

Optionally, the controllable multi-way valve is at least one of a controllable three-way valve, a two-position three-way electromagnetic valve, or a micro screw piston switch.

Optionally, the first driving assembly is arranged on the primary pipeline, or one first driving assembly is arranged on each branch pipeline; or the first driving assembly is coupled to the plurality of consumable chambers. The first driving assembly is any one of a peristaltic pump, an air pump, a gear pump, a screw pump or a rotor pump.

Optionally, the first driving assembly is coupled to the plurality of consumable chambers through a first common pipeline, and the first driving assembly is an air pump assembly. The air pump assembly includes: a second common pipeline coupled to the first common pipeline; a third common pipeline coupled to the second common pipeline; a fourth pipeline and a fifth pipeline coupled to two ends of the third common pipeline respectively; an air pump assembly including an air inlet and an air outlet coupled to the fourth pipeline and the fifth pipeline respectively; and an electromagnetic valve assembly including a first electromagnetic valve and a fourth electromagnetic valve arranged on the third common pipeline, a third electromagnetic valve arranged on the fourth pipeline and a second electromagnetic valve arranged on the fifth pipeline. The first electromagnetic valve, the second electromagnetic valve, the third electromagnetic valve and the fourth electromagnetic valve are normally-on electromagnetic valves or normally-off electromagnetic valves, the control unit is further configured to selectively control on states or off states of the first electromagnetic valve, the second electromagnetic valve, the third electromagnetic valve and the fourth electromagnetic valve of the electromagnetic valve assembly in accordance with a first driving state and a second driving state of the air pump assembly.

Optionally, the plurality of consumable chambers are respective consumable bottles or arranged in one consumable bottle, a cross section of the consumable bottle is of a circular or polygonal shape, and a cross section of the consumable chamber is of a circular shape, a rectangular shape or a customized pattern.

Optionally, the consumable extrusion control system further includes a flow sensor arranged on the pipeline, wherein the control unit is configured to control the first driving assembly to be switched between the first driving state and the second driving state in accordance with a detection result of the flow sensor.

In a third aspect, the present disclosure provides in some embodiments a consumable extrusion control method applied to the above-mentioned consumable extrusion control system, including: applying a first signal to the first driving assembly, to enable the first driving assembly to be switched to a first driving state; and applying a second signal to the first driving assembly, to enable the first driving assembly to be switched to a second driving state.

Optionally, the first driving assembly is a rotary pump, the consumable extrusion control method further includes: controlling the first driving assembly in the first driving state to rotate in a forward direction for a first predetermined duration in accordance with the first signal; and controlling the first driving assembly in the second driving state to rotate in a backward direction for a second predetermined duration in accordance with the second signal; wherein the first predetermined duration and the second predetermined duration are determined in accordance with a predetermined factor, and the predetermined factor includes at least one of a target amount of consumable extruded from one consumable chamber in the plurality of consumable chambers, diameters and lengths of the primary pipeline and the branch pipelines, or a rotation speed of the rotary pump.

Optionally, the first driving assembly is a rotary pump, the consumable extrusion control method further includes: in the case that the rotary pump rotates in a forward direction, obtaining a target consumable delivery amount detected by the flow sensor on the primary pipeline; in the case that the target consumable delivery amount meets a predetermined delivery amount, applying a third signal to the rotary pump; enabling the rotary pump to stop rotating in the forward direction and controlling the rotary pump to be switched to rotate in a backward direction in accordance with the third signal; and in the case that the rotary pump rotates in the backward direction and the amount of the consumable drawn from the pipeline and detected by the flow sensor is zero, enabling the rotary pump to stop rotating in the backward direction.

Optionally, the first driving assembly is an air pump assembly, the consumable extrusion control method further includes: applying a fourth signal to the air pump assembly, to enable a first electromagnetic valve and a third electromagnetic valve of the air pump assembly to be in an on state, and a second electromagnetic valve and a fourth electromagnetic valve of the air pump assembly are in an off state; or applying a fifth signal to the first driving assembly, to enable the first electromagnetic valve and the third electromagnetic valve of the air pump assembly to be in the off state, and enable the second electromagnetic valve and the fourth electromagnetic valve of the air pump assembly to be in the on state. The fourth signal is used to control the first driving assembly to be in a first driving state, and the fifth signal is used to control the first driving assembly to be in a second driving state.

In a fourth aspect, the present disclosure provides in some embodiments a consumable extrusion control device applied to the above-mentioned consumable extrusion control method, including: a first processing module configured to apply a first signal to the first driving assembly, to enable the first driving assembly to be in a first driving state; and a second processing module configured to apply a second signal to the first driving assembly, to enable the first driving assembly to be in a second driving state.

### BRIEF DESCRIPTION OF THE DRAWINGS

FIG. 1 is a schematic view showing a consumable extrusion control system according to a first embodiment of the present disclosure;

FIG. 2A is a schematic view showing the consumable extrusion control system according to a second embodiment of the present disclosure;

FIG. 2B is a sectional view of the consumable extrusion control system along a section line A in FIG. 2A;

FIG. 2C is a sectional view of the consumable extrusion control system along a section line B in FIG. 2A;

FIG. 3A is a schematic view showing the consumable extrusion control system in a first state according to a third embodiment of the present disclosure;

FIG. 3B is a schematic view showing the consumable extrusion control system in a second state in FIG. 3A:

FIG. 3C is a partial schematic view showing the consumable extrusion control system in FIG. 3A;

FIG. 4A is a schematic view showing the consumable extrusion control system in a first state according to a fourth embodiment of the present disclosure;

FIG. 4B is a schematic view showing the consumable extrusion control system in a second state in FIG. 4A;

FIG. 5A is a schematic view showing the consumable extrusion control system in a first state according to a fifth embodiment of the present disclosure;

FIG. 5B is a schematic view showing the consumable extrusion control system in a second state in FIG. 5A;

FIG. 6A is a schematic view showing the consumable extrusion control system in a first state according to a sixth embodiment of the present disclosure;

FIG. 6B is a schematic view showing the consumable extrusion control system in a second state in FIG. 6A;

FIG. 7A is a schematic view showing the consumable extrusion control system according to a seventh embodiment of the present disclosure;

FIGS. 7B and 7C are partial schematic views showing the consumable extrusion control system in FIG. 7A;

FIG. 8 is a schematic view showing the consumable extrusion control system according to an eighth embodiment of the present disclosure;

FIG. 9 is a flow chart of a consumable extrusion control method according to an embodiment of the present disclosure;

FIG. 10 is a schematic view showing a consumable extrusion control device according to an embodiment of the present disclosure;

FIG. 11 is a schematic view showing internal pipelines of an electric toothbrush according to an embodiment of the present disclosure;

FIG. 12 is an overall schematic view showing an electric toothbrush with a multiple-toothpaste-switching capability according to an embodiment of this disclosure;

FIG. 13 is a structural schematic view of a toothpaste chamber according to an embodiment of this disclosure.

### REFERENCE SIGNS LIST

1 main body
2 consumable chamber
3 first driving assembly
31 first pump head
32 second pump head
4 pipeline
41 primary pipeline
42 branch pipeline
421 first branch pipeline
422 second branch pipeline
5 consumable switching assembly
51 second driving assembly
52 diverter rotary disk
521 opening
61 first spinning motor
611 rotating shaft
62 second spinning motor
73 first air bag
74 second air bag
71 pneumatic element
72 control switch
8 cam structure
81 driving motor
82 cam
9 controllable multi-way valve
91 first connection port
92 second connection port
10 first common pipeline
11 second common pipeline
12 third common pipeline
13 air pump assembly
131 air inlet
132 air outlet
14 fourth pipeline
15 fifth pipeline
16 electromagnetic valve assembly
161 first electromagnetic valve
162 second electromagnetic valve
163 third electromagnetic valve
164 fourth electromagnetic valve

### DETAILED DESCRIPTION

In the following, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Such words as “first” and “second” involved in the specification and the appended claims are merely used to differentiate different objects rather than to represent any specific order. It should be appreciated that, the data used in this way may be replaced with each other, so as to implement the embodiments in an order other than that shown in the drawings or described in the specification. The expression “and/or” involved in the embodiments of the present disclosure may represent at least one of listed items. Further, the symbol “/” usually refers to “or”.

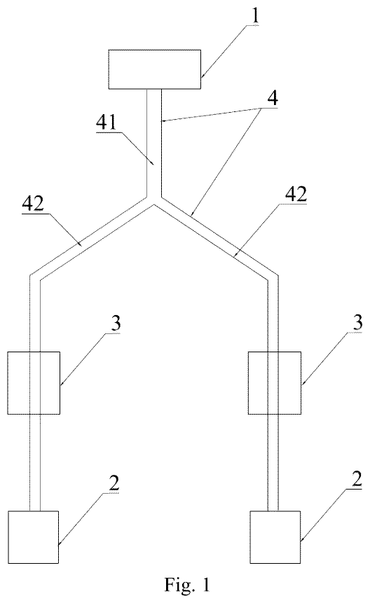

In the following, a detailed explanation of the consumable extrusion control system will be provided hereinafter in conjunction with FIGS. 1 to 8, the specific embodiments and application scenarios.

### First Embodiment

As shown in FIG. 1, the present disclosure provides in this embodiment a consumable extrusion control system, which includes: a main body 1, which can be a main body of an electric toothbrush or a main body of a beauty instrument; a plurality consumable chambers 2 coupled to the main body 1 through respective pipelines 4, and configured to provide consumables for the main body 1; a plurality of first driving assemblies 3 arranged on the respective pipelines 4 for the consumable chambers 2, and configured to provide a driving force for consumables in the consumable chamber 2; and a control unit arranged at the main body 1, and configured to control to switch to a corresponding first driving assembly 3 to operate, to deliver the consumable in a corresponding consumable chamber to the main body 1.

In this embodiment of the present disclosure, the pipeline 4 includes a primary pipeline 41 and at least one branch pipeline 42. An outlet of the primary pipeline 41 is in connection with the main body 1, an inlet of the primary pipeline 41 is in connection with an outlet of each branch pipeline 42, and an inlet of each branch pipeline 42 is in connection with a corresponding consumable chamber 2. One first driving assembly 3 is arranged on each branch pipeline 42.

Specially, the first driving assembly 3 includes a first driving state and a second driving state, wherein the first driving assembly 3 is configured to deliver, in the first driving state, the consumable from a target consumable chamber to the main body 1 through a corresponding pipeline, and configured to move, in the second driving state, the consumable remaining in the pipeline back into the corresponding consumable chamber.

It should be noted that, the first driving state is a state in which the consumable is moved out of the consumable chamber. In the embodiments of the present disclosure, there are various consumable chambers 2, and during the switching of the consumables, probably the primary pipeline 41 may be blocked due to the consumable remaining in the primary pipeline 41 in a previous consumable extrusion process, and/or probably two or more consumables are mixed in a next consumable extrusion process. In order to solve this problem, the first driving assembly 3 further includes the second driving state in which the consumable remaining the primary pipeline may be moved back into the corresponding consumable chamber 2.

In the embodiments of the present disclosure, one branch pipeline 42 is coupled to one consumable chamber 2, and different branch pipelines 42 are coupled to different consumable chambers 2. The primary pipeline 41 is coupled to the plurality of branch pipelines 42, and it is arranged at an end close to the main body 1. The outlet of each branch pipeline 42 is in connection with the inlet of the primary pipeline 41. Through the switching of the first driving assembly 3 between the first driving state and the second driving state, it is able for a product to automatically extrude two or more consumables through the switching, thereby to achieve the cleaning diversity through different consumables, and meet the user's requirements.

In the embodiments of the present disclosure, the consumable chambers 2 are used to accommodate the consumables of different types or at different concentrations. The consumables include, but not limited to, toothpaste, mouth wash, facial cleanser, skin care product, etc.

In the embodiments of the present disclosure, the first driving assembly 3 is capable of being switched between the first driving state and the second driving state, and it includes, but not limited to, rotary pump or air pump. For example, the rotary pump includes a peristaltic pump, a gear pump, a screw pump, a rotor pump, etc. The first driving assembly is switched between the first driving state and the second driving state through a rotation of the rotary pump in a forward direction and a backward direction.

When the first driving assembly 3 is the rotary pump, it is switched between the first driving state and the second driving state as follows. At first, the rotary pump rotates in the forward direction for a first predetermined duration, and then it rotates in the backward direction for a second predetermined duration. When another type of consumable is to be extruded, the rotary pump also rotates in the forward direction for the first predetermined duration, and then it rotates in the backward direction for the second predetermined duration. In this way, it is able to prevent the residual consumable remaining in the pipeline from blocking the pipeline and polluting the other consumable.

Optionally, when the consumable is toothpaste, the first predetermined duration is 3 s to 5 s, to ensure that 0.4 g to 1.2 g toothpaste is extruded. The second predetermined duration is 1 s to 3 s, to ensure that the toothpaste remaining in the pipeline is drawn back into the corresponding consumable chamber. It should be noted that, the first predetermined duration and the second predetermined duration are set in accordance with the amount of consumables extruded from the consumable chamber, diameters and lengths of the primary pipeline and the branch pipelines, and a rotation speed of the rotary pump. That is, in other embodiments of the present disclosure, the first predetermined duration and the second predetermined duration may have the other values, which will not be further particularly defined herein.

In another possible embodiment of the present disclosure, the consumable extrusion control system further includes a flow sensor arranged on the pipeline, and the control unit is configured to control the first driving assembly to be switched between the first driving state and the second driving state in accordance with a detection result of the flow sensor.

In this embodiment of the present disclosure, the amount of consumable delivered by the rotary pump is detected by the flow sensor. The rotary pump rotates in the forward direction until the amount of consumable detected by the flow sensor reaches a target value, then the rotary pump rotates in the backward direction until the amount of consumable drawn back into the consumable chamber and detected by the flow sensor is zero, and then enabling the rotary pump to stop rotating in the backward direction, so as to prevent the occurrence of the residual consumable in the pipeline. Preferably, the flow sensor is arranged on a common pipeline for multiple consumables. Optionally, the target value may be 0.4 g to 1.2 g.

### Second Embodiment

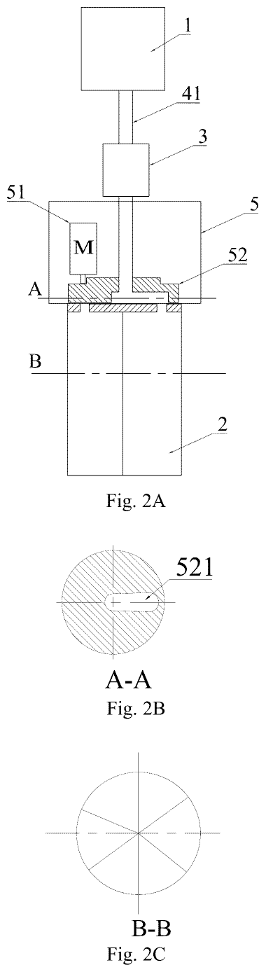

As shown in FIGS. 2A to 2C, in the second embodiment of the present disclosure, the consumable extrusion control system further includes a consumable switching assembly 5 configured to control a corresponding pipeline 4 to be switched between an open state and a closed state.

The control unit is configured to control the consumable switching assembly 5 and the first driving assembly 3 to operate, to deliver the consumables in different consumable chambers 2 to the main body 1.

To be specific, the consumable switching assembly 5 includes a second driving assembly 51 and a diverter rotary disk 52 coupled to the second driving assembly 51 and adapted to the plurality of consumable chambers 2. The diverter rotary disk 52 is arranged on the primary pipeline 41 and provided with an opening 521 through which the primary pipeline 41 is in connection with the corresponding consumable chambers 2. The diverter rotary disk 52 includes a first rotation position and a second rotation position, wherein at the first rotation position, one consumable chamber in the plurality of consumable chambers 2 is in connection with the primary pipeline 41 through the opening 521, and at the second rotation position, another consumable chamber in the plurality of consumable chambers 2 is in connection with the primary pipeline 41 through the opening 521.

The second driving assembly 51 is coupled to the diverter rotary disk 52, and configured to drive the diverter rotary disk 52 to rotate, to enable a corresponding one of the consumable chambers 2 to be in connection with the pipeline through the opening 521 of the diverter rotary disk 52. That is, the second driving assembly 51 drives the diverter rotary disk 52 to rotate, to switch between the first rotation position and the second rotation position.

Here, the first rotation position and the second rotation position correspond to the connection positions after switching to different consumable chambers 2 respectively.

In a possible embodiment of the present disclosure, the second driving assembly 51 in the consumable switching assembly 5 is preferably a driving motor. The second driving assembly 51 drives the diverter rotary disk 52 to rotate so that the opening 521 of the diverter rotary disk 52 is aligned with one consumable chamber in the plurality of consumable chambers 2, e.g., a consumable chamber A, and the consumable chamber A is in connection with the primary pipeline 41. In this way, during the operation of the first driving assembly 3, a corresponding consumable in the consumable chamber A is drawn by the first driving assembly 3. The second driving assembly 51 drives the diverter rotary disk 52 to rotate so that another consumable chamber in the plurality of consumable chambers 2, e.g., a consumable chamber B, is in connection with the primary pipeline 41. In this way, during the operation of the first driving assembly 3, a corresponding consumable in the consumable chamber B is drawn by the first driving assembly 3. Through the consumable switching assembly 5 and the second driving assembly 51, it is able to automatically switch between different consumable chambers.

It should be noted that, before it switches from the consumable chamber A to the consumable chamber B, it is necessary to move the consumable remaining in the primary pipeline 41 back to the consumable chamber A, and then it switches from the consumable chamber A to the consumable chamber B. For example, the first driving assembly 3 is a peristaltic pump, and when the peristaltic pump rotates in the forward direction, the consumable in the corresponding consumable chamber is drawn and extruded to an outlet of the main body 1 (e.g., when the main body 1 is an electric toothbrush, the outlet is on a toothbrush head). When the peristaltic pump rotates in the backward direction, the consumable remaining in the pipeline is drawn back into the corresponding consumable chamber.

Optionally, the consumable switching assembly 5 further includes a locking member (not shown) coupled to the diverter rotary disk 52, and configured to control the diverter rotary disk 52 to be switched between a locking state and an unlocking state; wherein in the locking state, the diverter rotary disk 52 is maintained stationary relative to the consumable chamber 2, and in the unlocking state, the diverter rotary disk 52 is driven to rotate by the second driving assembly 51.

In this embodiment of the present disclosure, through the locking member, when the diverter rotary disk 52 rotates to a position corresponding to a desired consumable chamber 2, the diverter rotary disk 52 is controlled to be in the locking state, so that the diverter rotary disk 52 is maintained stationary relative to the consumable chamber 2, so as to stably output/input the consumable from/into the consumable chamber.

Optionally, the second driving assembly 51 drives the diverter rotary disk 52 to rotate in an electric or manual manner, so as to switch between different consumable chambers. For example, the second driving assembly 51 is a hand wheel or a driving motor.

It should be noted that, in the present disclosure, the consumable chamber 2 may be an individual consumable bottle, or a plurality of consumable chambers 2 may be arranged in one consumable bottle. A cross section of the consumable bottle is of a circular, triangular, quadrilateral or another polygonal shape. A cross section of the consumable chamber is of a circular or rectangular shape, or a customized pattern, which will not be further particularly defined herein.

For example, when the cross section of the consumable bottle is of a circular shape, the cross sections of the plurality of consumable chambers 2 are of concentric circular shapes or sector-like shapes. As shown in FIGS. 2B and 2C, in a possible embodiment of the present disclosure, six consumable chambers 2 are arranged in one consumable bottle, and the cross section of each consumable chamber 2 is of a sector-like shape.

It should be noted that, an internal pipeline of the consumable chamber 2 is a straight pipeline, so when the cross sections of the consumable chambers 2 have different shapes, storage spaces for the corresponding consumables are different too.

Here, the cross sections of the consumable chambers 2 have different shapes or patterns to meet the requirements on the storage of different consumables. For example, the consumables are provided with different usage levels in accordance with the usage demands of the consumables, e.g., a first usage level to a third usage level with a descending order of priorities. At this time, the cross sections of different consumable chambers 2 are provided with different shapes in accordance with the usage levels, so as to store the consumables of different types at different storage capacities respectively.

It should be noted that, the plurality of consumable chambers 2 may be identified with different marks, e.g., colors, words or patterns, so as to enable a user to determine which consumable chamber has been switched to.

It should be further noted that, the consumable switching assembly 5 is actually used to control the open state or the closed state of the branch pipelines 42, i.e., the pipeline corresponding to the target consumable is controlled to be in the open state and the other pipeline is controlled to be in the closed state, so as to extrude the target consumable.

### Third Embodiment

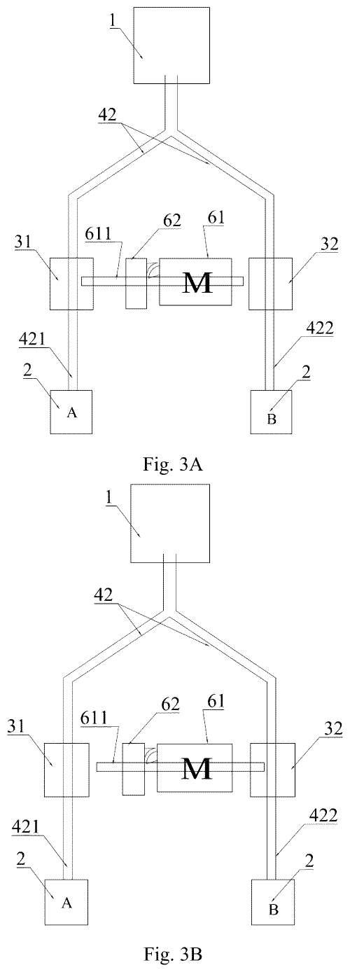

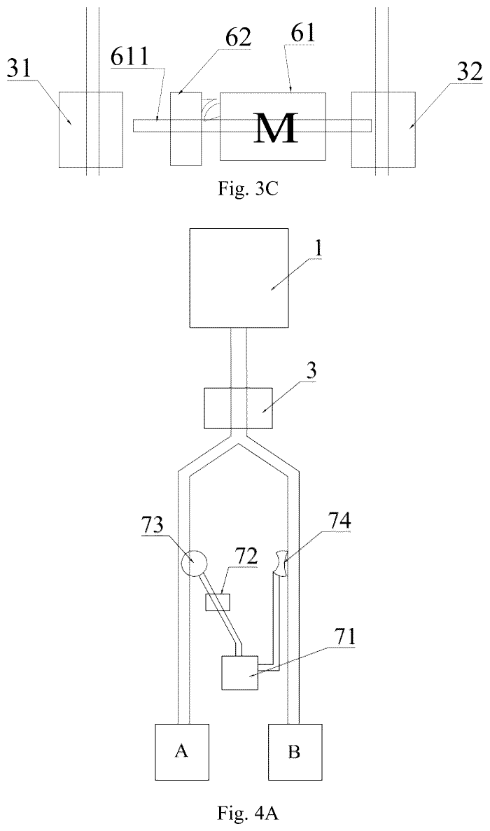

As shown in FIGS. 3A to 3C, the consumable switching assembly is a novel double-pump head peristaltic pump. To be specific, the first driving assembly 3 includes two pump heads arranged on the respective branch pipelines 42, a rotating shaft 611 coupled to the two pump heads and configured to drive the two pump heads, and a first spinning motor 61 coupled to the rotating shaft 611. The consumable switching assembly includes a second spinning motor 62 coupled to the rotating shaft 611. The second spinning motor 62 is configured to control to switch the rotating shaft 611 to be coupled to or decoupled from a corresponding one of the two pump heads, and the first spinning motor 61 is configured to drive the corresponding pump head to operate through the rotating shaft, so as to deliver the consumable in a corresponding branch.

In this embodiment of the present disclosure, the two pump heads include a first pump head 31 and a second pump head 32 arranged on the two branch pipelines 42 respectively. For example, in FIG. 3A, when the second spinning motor 62 rotates to drive the rotating shaft 611 to be coupled to the first pump head 31, the first spinning motor 61 is controlled to operate so as to deliver the consumable in the consumable chamber A to the main body 1. In FIG. 3B, when the second spinning motor 62 rotates to drive the rotating shaft 611 to be coupled to the second pump head 32, the first spinning motor 61 is controlled to operate so as to deliver the consumable in the consumable chamber B to the main body 1.

Further, in order to prevent the occurrence of the residual consumable, when the first spinning motor 61 rotates in the forward direction, the first pump head 31 operates to draw the consumable from the consumable chamber A, and when the first spinning motor 61 rotates in the backward direction, the first pump head 31 draws the consumable remaining in the branch pipelines 42 back into the consumable chamber A. Identically, when the rotating shaft 611 of the first spinning motor 61 is coupled to the second pump head 32, the residual consumable is processed in a same way.

It should be noted that, a one-way valve may also be arranged at the outlet of the main body 1. When the first spinning motor 61 rotates in the backward direction to draw the consumable remaining in the corresponding pipeline, air is preferentially drawn at an end of the pipeline. In this way, when the first spinning motor 61 rotates in the backward direction, the consumable remaining in the pipeline will be drawn back into the consumable chamber A, thereby minimizing the drawing of already extruded consumables into the consumable chamber.

It should be further noted that, the branch pipeline coupled to the consumable chamber A is a first branch pipeline 421, the branch pipeline coupled to the consumable chamber B is a second branch pipeline 422, the consumable in the consumable chamber A is a first consumable, and the consumable in the consumable chamber B is a second consumable. The residual consumable is further prevented as follows. During the switching of the multiple consumables, when the first pump head 31 operates to extrude the consumable in the consumable chamber A, a small part of the consumable in the first branch pipeline 421 inevitably enters the second branch pipeline 422. Hence, after the first consumable has been extruded by the first pump head 31, the second spinning motor 62 is controlled to switch to the second pump head 32 and the second spinning motor 62 rotates in the forward direction (e.g., for 0.5 s) so that the second pump head 32 extrudes the first consumable remaining in the second branch pipeline 422 out of the second branch pipeline 422. Then, the second spinning motor 62 is controlled to switch to the first pump head 31, and then the first spinning motor 61 is controlled to rotate in the backward direction for 1 s to 3 s so that the first pump head 31 draws the first consumable remaining in the first branch pipeline 421 back into the consumable chamber A.

It should be further noted that, in order to prevent the occurrence of the residual second consumable remaining in the first branch pipeline 421 or the residual first consumable remaining in the second branch pipeline 422, the first branch pipeline 421 and the second branch pipeline 422 may be designed as short as possible. In this way, when the first pump head 31 operates, the consumable enters from the first branch pipeline 421 into the primary pipeline, with merely a small amount of consumable entering the second branch pipeline 422. When the first pump head rotates in the backward direction, it can also ensure that the small amount of the first consumable in the second branch pipeline 422 is drawn back into the consumable chamber A.

As shown in FIG. 3C, the second spinning motor 62 functions as to change a position of the rotating shaft 611. In another possible embodiment of the present disclosure, no second spinning motor 62 is provided, and the position of the rotating shaft 611 is changed manually. That is, the rotating shaft of the first spinning motor 61 is moved manually by the user, so as to be coupled to the first pump head 31 or the second pump head 32. For example, when the consumable extrusion control system is applied to an electric toothbrush, a stator of the first spinning motor 61, the first pump head 31 and the second pump head 32 are fixed onto the electric toothbrush. The rotating shaft of the first spinning motor 61 can be set as: when the rotating shaft of the first spinning motor 61 is moved to the left, it is coupled to the first pump head 31, and when it is moved to the right, it is coupled to the second pump head 32. Alternatively, when the rotating shaft of the first spinning motor 61 is moved to the left, it is coupled to the second pump head 32, and when it is moved to the right, it is coupled to the first pump head 31.

### Fourth Embodiment

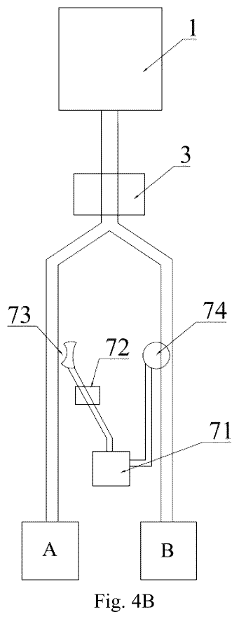

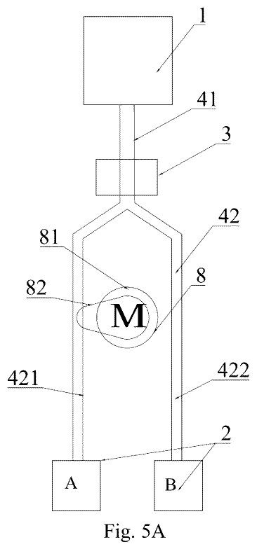

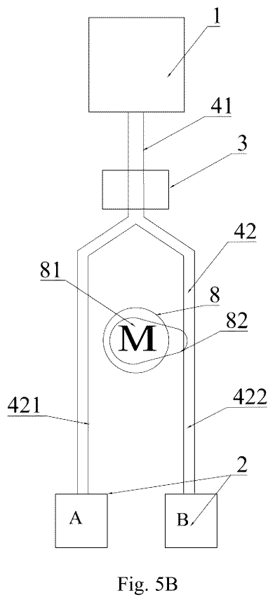

In this embodiment of the present disclosure, as shown in FIGS. 4A to 4B, the consumable switching assemble includes: a plurality of air bags arranged on the respective branch pipelines 42; a pneumatic element 71 configured to inflate the plurality of air bags; and a control switch 72 configured to control the pneumatic element 71 to be switched between a state where the pneumatic element is in connection with a corresponding air bag and a state where the pneumatic element is not in connection with the corresponding air bag. The consumable switching assembly is configured to control the pneumatic element 71 to be in connection with, or not in connection with, a corresponding air bag through the control switch 72, to control the consumable chamber to be switched between a state where the consumable chamber is coupled to the corresponding branch pipeline and a state where the consumable chamber is decoupled from the corresponding branch pipeline through an inflated state or an uninflated state of the air bag.

It should be noted that, the quantity of air bags may be plural. In this embodiment of the present disclosure, two air bags are taken as an example. The air bags includes a first air bag 73 and a second air bag 74 arranged on the two branch pipelines respectively.

The first air bag 73 and the second air bag 74 are inflated by the pneumatic element 71 so as to be switched to be in the inflated state. In the inflated state, the first air bag 73 and the second air bag 74 abut against the branch pipelines respectively, so as to close the branch pipelines. When the first air bag 73 and the second air bag 74 are in the uninflated state, the branch pipelines are in the open state.

It should be noted that, as shown in FIG. 4A, when the first air bag 73 is in the inflated state and the second air bag 74 is in the uninflated state, the branch pipeline corresponding to the second air bag 74 is in the open state, and the consumable in the consumable chamber B is delivered by the first driving assembly 3 to the main body 1. As shown in FIG. 4B, when the first air bag 73 is in the uninflated state and the second air bag 74 is in the inflated state, the branch pipeline corresponding to the first air bag 73 is in the open state, and the consumable in the consumable chamber A is delivered by the first driving assembly 3 to the main body 1.

In this embodiment of the present disclosure, the pneumatic element 71 is an element with a function of outputting or adsorbing air, e.g., an air pump, and the control switch 72 is a switch capable of being turned on and off.

As shown in FIG. 4A, in the case that the first air bag 73 is in a first inflated state and the second air bag 74 is in the uninflated state, the control switch 72 is in a normally-off state. At this time, the first air bag 73 abuts against the first branch pipeline so that the first branch pipeline is in the closed state, and the first driving assembly 3 operates to draw the consumable from the consumable chamber B or draw the consumable back into the consumable chamber B.

As shown in FIG. 4B, the control switch 72 is in a normally-on state, e.g., the control switch is a normally-off electromagnetic valve and it is powered on to be in the normally-on state. In the case that the control switch 72 is in the normally-on state, the pneumatic element 71 (e.g., an air pump, an air pump motor that rotates in a clockwise direction) draws all air in the first air bag 73 into the second air bag 74, and then the control switch 72 is in the normally-off state (e.g., the electromagnetic valve is powered off). At this time, the second air bag 74 abuts against the second branch pipeline corresponding to the consumable chamber B to enable the second branch pipeline to be in the closed state. Hence, the first driving assembly 3 operates to draw the consumable from the consumable chamber B or draw the consumable back into the consumable chamber B (in the case that the air pump motor rotates in a counterclockwise direction, air in the second air bag 74 is drawn into the first air bag 73, provided that the electromagnetic valve is turned on). In the present disclosure, it can achieve the purpose of switching between different consumable chambers by controlling the inflation states of the first air bag 73 and the second air bag 74.

Optionally, for the structure in FIG. 4A, in order to prevent the occurrence of the residual consumable, the first driving assembly 3 (e.g., a peristaltic pump) operates in the forward direction for a first predetermined duration to draw the consumable in the consumable chamber B to the outlet of the main body, and then rotates in the backward direction for a second predetermined duration to draw the consumable remaining in the pipeline back into the consumable chamber B. For the structure in FIG. 4B, in order to prevent the occurrence of the residual consumable, the first driving assembly 3 operates in the forward direction for the first predetermined duration so as to draw the consumable in the consumable chamber A to the outlet of the main body, and then rotates in the backward direction for the second predetermined duration so as to draw the consumable remaining in the pipeline back into the consumable chamber A.

### Fifth Embodiment

In this embodiment of the present disclosure, as shown in FIGS. 5A and 5B, the consumable switching assembly includes a cam structure 8 which includes a driving motor 81 and a cam 82 rotatably coupled to the driving motor 81. The consumable switching assembly is configured to drive the cam 82 to be switched between a first driving position and a second driving position through the driving motor 81, to control the consumable chamber to be switched between a state where the consumable chamber is coupled to the corresponding branch pipeline and a state where the consumable chamber is decoupled from the corresponding branch pipeline.

To be specific, the cam 82 is switched between the first driving position and the second driving position through the driving motor 81, to control the corresponding consumable chamber 2 to be in connection with, or not in connection with, the primary pipeline 41. For example, in FIG. 5A, at the first driving position, the cam 82 abuts against the first branch pipeline 421 to enable the first branch pipeline 421 to be in the closed state, thereby to enable the corresponding consumable chamber to be not in connection with the primary pipeline 41. The second branch pipeline 422 is in the open state, and the consumable chamber corresponding to the second branch pipeline 422 is in connection with the primary pipeline 41. In FIG. 5B, at the second driving position, the cam 82 abuts against the second branch pipeline 422 to enable the second branch pipeline 422 to be in the closed state, thereby to enable the corresponding consumable chamber to be not in connection with the primary pipeline 41. The first branch pipeline 421 is in the open state, and the consumable chamber corresponding to the first branch pipeline 421 is in connection with the primary pipeline 41.

In this embodiment of the present disclosure, through controlling the cam 82 to abut against the first branch pipeline 421 or the second branch pipeline 422, it is able to switch between a second delivery state and a first delivery state, thereby to switch between different consumable chambers. In the first delivery state, the consumable switching assembly is configured to control the first branch pipeline 421 in the plurality of branch pipelines to deliver the first consumable, and in the second delivery state, the consumable switching assembly is configured to control the second branch pipeline 422 in the plurality of branch pipelines to deliver the second consumable.

Optionally, no automatic cam structure 8 is provided, and a cam switch which is rotated manually is provided. Similar to the principle of a motor-driven cam, when the cam is rotated manually to the left, the consumable on the right is to be drawn, and when the cam is rotated manually to the right, the consumable on the left is to be drawn.

### Sixth Embodiment

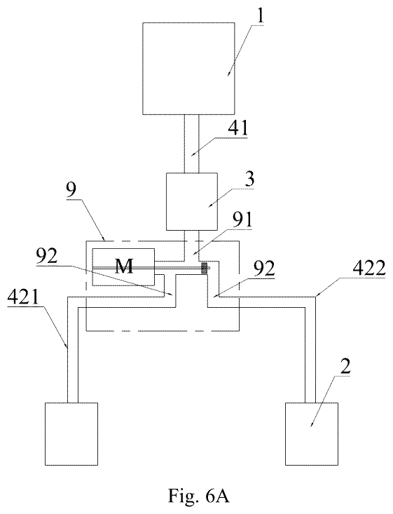

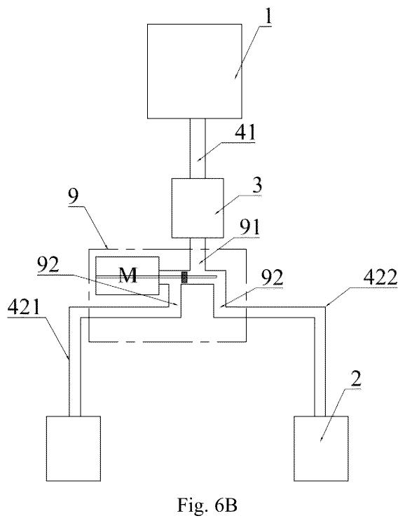

As shown in FIGS. 6A and 6B, in this embodiment of the present disclosure, the consumable switching assembly is a controllable multi-way valve 9, which includes one first connection port 91 and at least two second connection ports 92. The first connection port 91 is in connection with the primary pipeline, the second connection ports 92 are in connection with the branch pipelines respectively; the controllable multi-way valve 9 includes a first connection state and a first non-connection state, the controllable multi-way valve 9 is configured to, in the first connection state, couple the primary pipeline 41 to any one of the branch pipelines 42, and configured to, in the first non-connection state, decouple the primary pipeline 41 from any one of the branch pipelines 42, and the control unit is further configured to control the controllable multi-way valve 9 to be switched between the first connection state and the first non-connection state.

In this embodiment of the present disclosure, through adjusting the first connection port 91 to be in connection with any second connection port 92 of the controllable multi-way valve, the primary pipeline 41 is in connection with any branch pipeline 42 according to the practical need, so as to deliver the consumable in the consumable chamber 2 corresponding to the branch pipeline 42 to the main body 1 for use. Different consumable chambers 2 can accommodate different types of consumables, and when the consumable is toothpaste, it is able for the main body 1 to provide different types of toothpaste according to the practical needs, so as to meet the user's requirements for different toothpaste effects.

For example, the first driving assembly 3 is a peristaltic pump. The control unit sends a valve control signal to the controllable multi-way valve 9 and sends a pump control signal to the peristaltic pump according to the practical need. The valve control signal is used to control the controllable multi-way valve 9, so as to enable the primary pipeline 41 to be in connection with any branch pipeline 42, thereby to enable the main body 1 to be in connection with the target consumable chamber corresponding to the desired consumable. The pump control signal is used to control an operating state of the peristaltic pump. When the peristaltic pump rotates in the forward direction, a negative pressure is generated in the consumable chamber, so that the consumable in the consumable chamber flows to the main body 1. When the peristaltic pump rotates in the backward direction, the consumable in the primary pipeline, the branch pipeline and the controllable multi-way valve moves back into the consumable chamber, so as to prevent the consumables of different types from being mixed during the switching.

In this embodiment of the present disclosure, the controllable multi-way valve 9 is a controllable three-way valve, a two-position three-way electromagnetic valve or a micro screw piston switch, etc.

In this embodiment of the present disclosure, for ease of understanding, the controllable multi-way valve is illustratively shown in the case that there are two consumable chambers 2. The controllable multi-way valve 9 may be a controllable three-way valve or a two-position three-way electromagnetic valve. It should be noted that, in the case that the controllable multi-way valve 9 is an electromagnetic valve and the consumable is toothpaste, the toothpaste is gel-like, and in order to facilitate the output and retrieving of the toothpaste, a channel in the electromagnetic valve has a large size. Similar to the two-position three-way electromagnetic valve, the micro screw piston switch forms a passage in the case of being powered on, so as to form the first connection state; and the micro screw piston switch forms another passage in the case of being powered off, so as to form the second connection state. Through powering on or off the controllable multi-way valve, it is able to switch between the first connection state and the first non-connection state, thereby to switch between different consumable chambers.

As shown in FIGS. 6A and 6B, in this embodiment of the present disclosure, the controllable multi-way valve 9 is a micro screw piston switch. In the case that the micro screw piston switch in FIG. 6A is not powered on, the first connection port 91 of the micro screw piston switch and the second connection port 92 coupled to the first branch pipeline 421 are opened, and the second connection port 92 coupled to the second branch pipeline 422 is closed, so that the primary pipeline 41 is in connection with the first branch pipeline 421 and not in connection with the second branch pipeline 422. During the operation of the first driving assembly 3, the consumable in the consumable chamber coupled to the first branch pipeline 421 is drawn under the effect of the negative pressure. In the case that the micro screw piston switch in FIG. 6B is powered on, the first connection port 91 of the micro screw piston switch and the second connection port 92 coupled to the first branch pipeline 421 are closed, and the second connection port 92 coupled to the second branch pipeline 422 is opened, so that the primary pipeline 41 is in connection with the second branch pipeline 422 and not in connection with the first branch pipeline 421. During the operation of the first driving assembly 3, the consumable in the consumable chamber coupled to the second branch pipeline 422 is drawn under the effect of the negative pressure.

In FIGS. 6A and 6B, the residual consumable is processed as follows. In FIG. 6A, the first driving assembly (e.g., the peristaltic pump) rotates in the forward direction for a first predetermined duration so as to extrude the consumable in the consumable chamber coupled to the first branch pipeline 421, and then rotates in the backward direction for a second predetermined duration so as to draw the consumable in the first branch pipeline 421 and the primary pipeline 41 back into the consumable chamber coupled to the first branch pipeline 421. In contrast, in FIG. 6B, the peristaltic pump rotates in the forward direction for the first predetermined duration so as to extrude the consumable in the consumable chamber coupled to the second branch pipeline 422, and then rotates in the backward direction for the second predetermined duration so as to draw the consumable in the pipeline back into the consumable chamber coupled to the second branch pipeline 422.

In the present disclosure, optionally, the controllable multi-way valve 9 is arranged in such a manner as to switch the consumable manually, i.e., a driving motor of the controllable multi-way valve 9 is removed, and a switch operated manually is provided. An operating principle thereof is the same as that of the automatic switching, which will not be further elaborated here.

In another possible embodiment of the present disclosure, when the controllable multi-way valve is a two-position three-way electromagnetic valve, a scheme for preventing the occurrence of the residual consumable is similar to that of the micro screw piston switch, which will not be further elaborated here.

### Seventh Embodiment

In this embodiment of the present disclosure, the first driving assembly 3 is arranged flexibly. During the implementation, the first driving assembly 3 is arranged at an end close to the main body 1, the first connection port 91 of the controllable multi-way valve 9 is coupled to the primary pipeline 41 close to the main body 1, and the second connection port 92 is coupled to the branch pipeline 42 coupled to the consumable chamber, as shown in FIGS. 6A and 6B. However, in this embodiment of the present disclosure, the first driving assembly 3 is arranged at an end far away from the main body 1, and coupled to the plurality of consumable chambers.

Here, the first driving assembly 3 is, for example, a rotary pump. Through the rotation of the rotary pump in the forward direction and the backward direction, it is able to switch the first driving assembly between the first driving state and the second driving state.

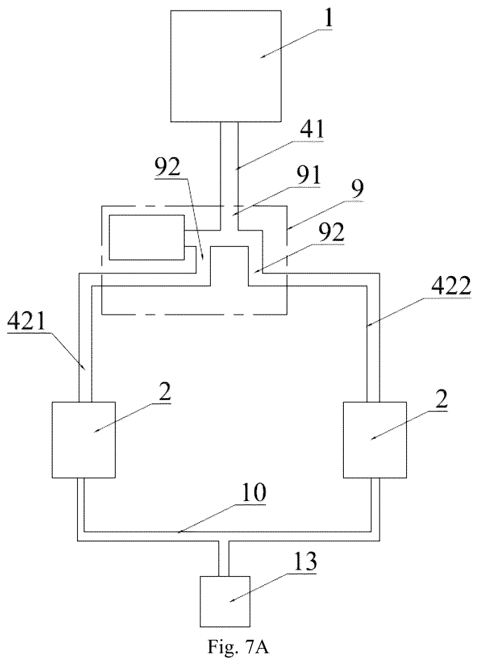

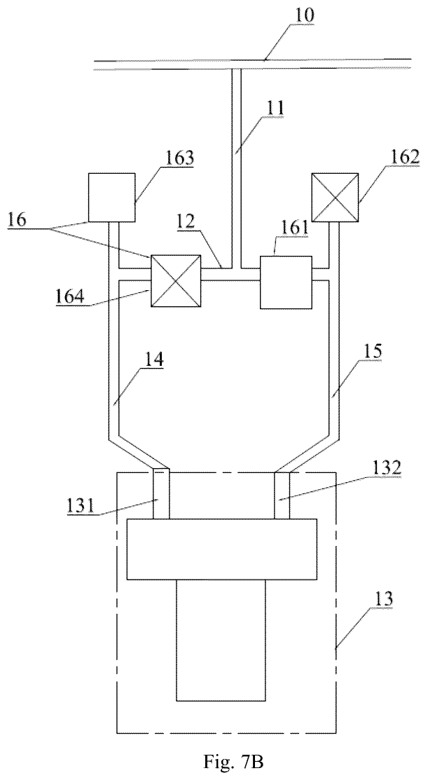

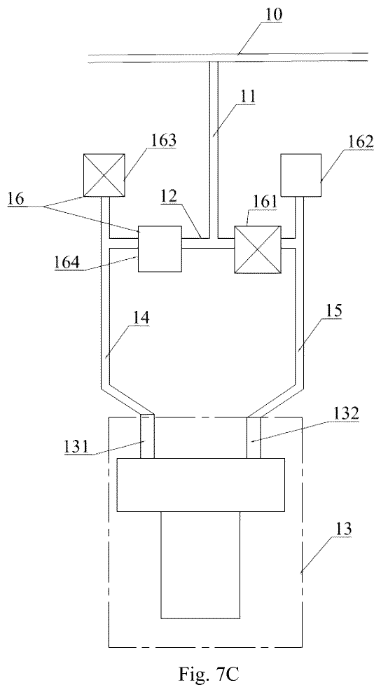

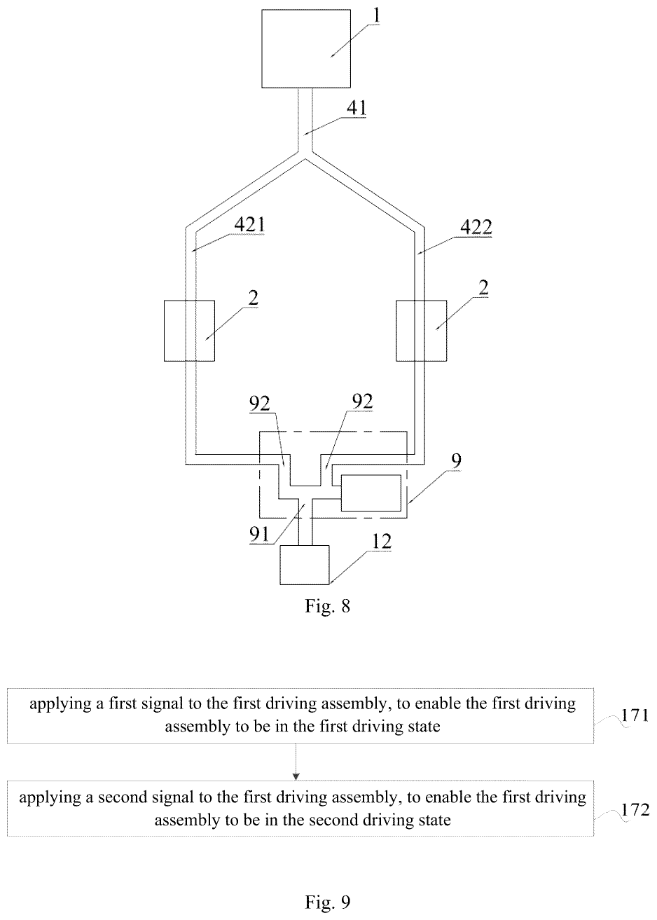

It should be noted that, a position of the controllable multi-way valve 9 is set flexibly, e.g., a position of the two-position three-way electromagnetic valve in FIG. 7A, or a position of the two-position three-way electromagnetic valve in FIG. 8, which will not be further particularly defined herein.

To be specific, as shown in FIGS. 7A to 7C, in this embodiment of the present disclosure, the consumable switching assembly is the controllable multi-way valve 9 arranged on the primary pipeline 41 close to the main body 1. The first driving assembly 3 is an air pump assembly 13 arranged at an end far from the main body 1 and coupled to a plurality of consumable chambers 2.

Further, as shown in FIGS. 7B and 7C, the first driving assembly 3 is coupled to the plurality of consumable chambers 2 through a first common pipeline 10, and the first driving assembly 3 is an air pump assembly. The air pump assembly includes: a second common pipeline 11 coupled to the first common pipeline 10; a third common pipeline 12 coupled to the second common pipeline 11; a fourth pipeline 14 and a fifth pipeline 15 coupled to two ends of the third common pipeline 12 respectively; an air pump assembly 13 including an air inlet 131 and an air outlet 132 coupled to the fourth pipeline 14 and the fifth pipeline 15 respectively; and an electromagnetic valve assembly 16 including a first electromagnetic valve 161 and a fourth electromagnetic valve 164 arranged on the third common pipeline 12, a third electromagnetic valve 163 arranged on the fourth pipeline 14 and a second electromagnetic valve 162 arranged on the fifth pipeline 15. The first electromagnetic valve 161, the second electromagnetic valve 162, the third electromagnetic valve 163 and the fourth electromagnetic valve 164 are normally-on electromagnetic valves or normally-off electromagnetic valves. The control unit is further configured to selectively control on states or off states of the first electromagnetic valve 161, the second electromagnetic valve 162, the third electromagnetic valve 163 and the fourth electromagnetic valve 164 of the electromagnetic valve assembly 16 in accordance with a first driving state and a second driving state of the air pump assembly 13.

For example, the first electromagnetic valve 161, the second electromagnetic valve 162, the third electromagnetic valve 163 and the fourth electromagnetic valve 164 of the electromagnetic valve assembly 16 are in the normally-off state in the case of being not powered on, i.e., they are normally-off electromagnetic valves. In a state as shown in FIG. 7B where the consumable is extruded under the effect of a positive pressure, the control unit controls the first electromagnetic valve 161 and the third electromagnetic valve 163 to be powered on, and controls the second electromagnetic valve 162 and the fourth electromagnetic valve 164 to be maintained in the off state, so as to close the fourth pipeline 14 and open the fifth pipeline 15, thereby to enable the air pump assembly 13 to extrude the consumable under the effect of the positive pressure.

In a state as shown in FIG. 7C where the residual consumable is drawn under the effect of the negative pressure, the control unit controls the second electromagnetic valve 162 and the fourth electromagnetic valve 164 to be powered on, and controls the first electromagnetic valve 161 and the third electromagnetic valve 163 to be maintained in the off state, so as to open the fourth pipeline 14 and close the fifth pipeline 15, thereby to enable the air pump assembly 13 to draw the consumable in the pipeline back into the consumable chamber under the effect of the positive pressure.

In this embodiment of the present disclosure, through the controllable multi-way valve 9, it is able to switch the pipelines corresponding to the consumables in different consumable chambers. Through the cooperation of the air pump assembly 13 with the electromagnetic valve assembly 16, it is able to extrude the consumable under the effect of the positive pressure and draw the consumable back into the consumable chamber under the effect of the negative pressure, thereby to prevent the occurrence of the residual consumable.

### Eighth Embodiment

As shown in FIG. 8, in this embodiment of the present disclosure, the controllable multi-way valve 9 and the first driving assembly are arranged at an end far away from the main body 1. For example, the first driving assembly 3 in FIG. 8 is a pneumatic device, e.g., an air pump, and the controllable multi-way valve 9 is a controllable three-way valve, a two-position three-way electromagnetic valve, or a micro spiral piston switch, etc.

In a word, in the above-mentioned schemes, the consumable switching assembly actually forms a valve bank switch for switching the pipelines, and it is used to control to select the corresponding consumable pipelines. In the second to eighth embodiments, apart from the consumable switching assembly, the other structures are the same. Different from the second to sixth embodiments, in the seventh and eighth embodiments, the first driving assembly 3 is arranged at an end far away from the main body. In the first embodiment as shown in FIG. 1, the pipelines and the power units are arranged separately, so as to control the extrusion of the consumable in the corresponding consumable chamber independently.

It should be noted that, in the above schemes, the peristaltic pump and the air pump may be replaced by a rotary pump, e.g., a gear pump, a screw pump or a rotor pump, etc. When the rotary pump is adopted, the residual consumable in the pipeline is processed through the rotation of the rotary pump in the forward direction and the backward direction. When the air pump is adopted, the residual consumable in the pipeline is processed through the positive pressure and the negative pressure generated by the air pump.

It should be noted that in the above schemes, at least two consumable chambers can be separate consumable chambers, or arranged in a single tank, e.g., a consumable tank containing toothpaste, mouth wash, cleaning fluid, facial cleanser or skin care product, which will not be further particularly defined herein.

According to the consumable extrusion control system in the embodiments of the present disclosure, it is able to provide the consumables with different flavors and/or different functions to meet the user's requirements. Taking toothpaste as an example and categorizing by flavor, the flavors of the toothpaste include strawberry, yellow peach, nectarine, crunchy peach, green grape, lemon, watermelon, apple, grapefruit, sea salt, milk ice cream, chocolate ice cream, grape, pineapple, orange, blueberry, waxberry, carambola, osmanthus, rose, jasmine, or magnolia flower. Functions of the toothpaste include stain removal, breath-freshening, gingiva protection, caries prevention, teeth whitening, anti-irritation, smoke stain removal, internal heat reduction, child-specific or pregnant-specific.

According to the consumable extrusion control system, it is also able to provide an appropriate care scheme for the user. Taking dental care as an example, a tank includes four consumable chambers containing toothpaste with a stain removal function, a polishing agent, a tooth repairing agent and toothpaste with a whitening function. The consumable chambers are switched sequentially, so as to remove stains, and then polish teeth, and then repair teeth and then whiten teeth. In this way, it is able for the user to implement a complete set of dental care processes at home.

Taking skin care as an example, a tank includes six consumable chambers containing a cleansing material, a toner, an essence, an eye cream, a body lotion, a face cream and a sun cream respectively. The consumable chambers are switched sequentially, so as to cleanse the face, and then apply the toner, and then apply the essence, and then apply the eye cream, and then apply the body lotion, and then apply the face cream, and then apply the sun cream. In this way, it is able for the user to implement a complete set of skin care processes at home.

According to the consumable extrusion control system in the embodiments of the present disclosure, it is able to provide the consumables having different flavors, different color and different functions, so as to meet the user's requirements. In addition, in combination with a corresponding switching control program, it is able to customize a consumable extrusion sequence according to user needs, so as to meet the user's requirement on personal care.

According to the consumable extrusion control system in the embodiments of the present disclosure, the rotary pump is used to deliver the consumable, and the residual consumable in the pipeline is processed through the rotation of the rotary pump in the forward direction and the backward direction, so as to prevent the user experience from being adversely affected when the consumables of different types are mixed.

A consumable extrusion control method applied to the consumable extrusion control system will be described hereinafter in conjunction with FIGS. 1 to 9 as well as the embodiments and application scenarios.

As shown in FIG. 9, the present disclosure provides in some embodiments a consumable extrusion control method applied to the consumable extrusion control system in FIGS. 1 to 8, which includes: Step 171 of applying a first signal to the first driving assembly, to enable the first driving assembly to be switched to a first driving state; and Step 172 of applying a second signal to the first driving assembly, to enable the first driving assembly to be switched to a second driving state.

According to the embodiments of the present disclosure, the first signal is applied to the first driving assembly, so that the first driving assembly is in the first driving state and delivers the consumable in the consumable chamber 2 to the main body 1. There are at least two consumable chambers, so it is able for a product to automatically extrude two or more consumables, thereby to achieve the dental cleaning diversity through different consumables, and meet the user's requirements. In addition, the second signal is applied to the first driving assembly, so that the first driving assembly is in the second driving state, and moves the consumable remaining in the primary pipeline and the branch pipelines back into the corresponding consumable chamber, so it is able to prevent the pipeline from being blocked due to the residual consumable remaining in the common pipeline in a previous consumable extrusion process and prevent two or more consumables from being mixed in a next consumable extrusion process.

For example, in an application scenario, Step 171 is performed prior to Step 172, so as to extrude the consumable to the main body and then draw the consumable remaining in the pipeline back into the consumable chamber.

Optionally, the first driving assembly is a rotary pump. The consumable extrusion control method further includes: controlling the first driving assembly in the first driving state to rotate in a forward direction for a first predetermined duration in accordance with the first signal; and controlling the first driving assembly in the second driving state to rotate in a backward direction for a second predetermined duration in accordance with the second signal. The first predetermined duration and the second predetermined duration are determined in accordance with a predetermined factor, and the predetermined factor includes at least one of: a target amount of consumable extruded from one consumable chamber in the plurality of consumable chambers; diameters and lengths of the primary pipeline and the branch pipelines; or a rotation speed of the rotary pump.

In the embodiments of the present disclosure, in the case that the first driving assembly includes the rotary pump, the first driving assembly is controlled to rotate in the forward direction for the first predetermined duration or rotate in the backward direction for the second predetermined duration in accordance with the first signal or the second signal, so as to switch the first driving assembly between the first driving state and the second driving state. When the rotary pump is a peristaltic pump, the peristaltic pump is controlled to rotate in the forward direction for the first predetermined duration in accordance with the first signal, and then rotate in the backward direction for the second predetermined duration in accordance with the second signal. During the extrusion of another consumable, the peristaltic pump also rotates in the forward direction for the first predetermined duration, and then rotates in the backward direction for the second predetermined duration. In this way, it is able to prevent the residual consumable remaining in the pipeline from blocking the pipeline and polluting the next consumable.

The first predetermined duration and the second predetermined duration disclosed herein are determined in accordance with at least one of the predetermined factors, and the predetermined factors include at least one of the target amount of consumable extruded from one consumable chamber in the at least two consumable chambers, the diameters and lengths of the primary pipeline and the branch pipelines, or the rotation speed of the rotary pump. The predetermined factors may also include other factor capable of affecting input or output power of the first driving assembly. It should be noted that, the first predetermined duration and the second predetermined duration may have configured or preconfigured values. For example, when the consumable is toothpaste, the first predetermined duration is 3 s to 5 s so as to extrude 0.4 g to 1.2 g toothpaste. The second predetermined duration is 1 s to 3 s. In the other embodiments of the present disclosure, the first predetermined duration may have another value, which will not be further particularly defined herein.

It should be noted that, a one-way valve is arranged at the outlet of the main body. When the rotary pump rotates in the backward direction to draw the residual consumable remaining in the corresponding pipeline, air is preferentially drawn at an end of the pipeline. In this way, when the rotary pump rotates in the backward direction, the consumable remaining in the pipeline will be drawn back into the consumable chamber, thereby minimizing the drawing of already extruded consumables into the consumable chamber.

Optionally, the first driving assembly is a rotary pump. The consumable extrusion control method further includes: in the case that the rotary pump rotates in a forward direction, obtaining a target consumable delivery amount detected by the flow sensor on the primary pipeline; in the case that the target consumable delivery amount meets a predetermined delivery amount, applying a third signal to the rotary pump; enabling the rotary pump to stop rotating in the forward direction and controlling the rotary pump to be switched to rotate in a backward direction in accordance with the third signal; and in the case that the rotary pump rotates in the backward direction and the amount of the consumable extracted from the pipeline and detected by the flow sensor is zero, enabling the rotary pump to stop rotating in the backward direction.

In the embodiments of the present disclosure, the consumable extrusion control system includes the flow sensor for detecting the amount of consumable delivered by the peristaltic pump. The peristaltic pump rotates in the forward direction until the amount of consumable detected by the flow sensor reaches a predetermined delivery amount (a configured or preconfigured target value), then the peristaltic pump rotates in the backward direction until the amount of consumable drawn back into the consumable chamber and detected by the flow sensor is zero, and then it enables the peristaltic pump to stop rotating in the backward direction, so as to prevent the consumable remaining in the pipeline. That is, the amount of consumable delivered by the rotary pump is detected by the flow sensor, the rotary pump rotates in the forward direction until the amount of consumable reaches the target value and then rotates in the backward direction, and when the amount of consumable drawn back into the consumable chamber and detected by the flow sensor is zero, it enables the rotary pump to stop rotating in the backward direction.

Preferably, the flow sensor is arranged on the primary pipeline of the consumable extrusion control system.

Optionally, the target value of the predetermined delivery amount is 0.4 g to 1.2 g.

In another possible embodiment of the present disclosure, optionally, the first driving assembly is an air pump assembly. The consumable extrusion control method disclosed herein further includes: applying a fourth signal to the air pump assembly, to enable a first electromagnetic valve and a third electromagnetic valve of the air pump assembly to be in an on state, and enable a second electromagnetic valve and a fourth electromagnetic valve of the air pump assembly to be in an off state; or applying a fifth signal to the first driving assembly, to enable the first electromagnetic valve and the third electromagnetic valve of the air pump assembly to be in the off state, and enable the second electromagnetic valve and the fourth electromagnetic valve of the air pump assembly to be in the on state. The fourth signal is used to control the first driving assembly to be in a first driving state, and the fifth signal is used to control the first driving assembly to be in a second driving state.

In the embodiments of the present disclosure, the fourth signal is applied to the air pump assembly, so as to control the first driving assembly to be in the first driving state. For example, as shown in FIGS. 7A to 7C, the first electromagnetic valve 161, the second electromagnetic valve 162, the third electromagnetic valve 163 and the fourth electromagnetic valve 164 are all in the normally-off state in the case of not being powered on. In a state as shown in FIG. 7B where the consumable is extruded under the effect of a positive pressure, the control unit controls the first electromagnetic valve 161 and the third electromagnetic valve 163 to be powered on, and controls the second electromagnetic valve 162 and the fourth electromagnetic valve 164 to be maintained in the off state, so as to close the fourth pipeline 14 and open the fifth pipeline 15, thereby to enable the air pump assembly 13 to extrude the consumable under the effect of the positive pressure.

The fifth signal is applied to the air pump assembly, so as to control the first driving assembly to be in the second driving state. For example, in a state as shown in FIG. 7C where the residual consumable is extruded under the effect of a negative pressure, the control unit controls the second electromagnetic valve 162 and the fourth electromagnetic valve 164 to be powered on, and controls the first electromagnetic valve 161 and the third electromagnetic valve 163 to be maintained in the off state, so as to open the fourth pipeline 14 and close the fifth pipeline 15. At this time, air in the consumable chamber is drawn by the air pump to generate the negative pressure. The consumable in the pipeline is drawn by the air pump assembly 13 back into the consumable chamber under the effect of the positive pressure, so as to prevent the occurrence of the residual consumable.

According to the consumable extrusion control method in the embodiments of the present disclosure, it is able for one product to automatically extrude two or more consumables, so as to meet the user's requirements. In addition, it is able to prevent two or more consumables from being mixed during the switching.

According to the consumable extrusion control method in the embodiments of the present disclosure, it is able to provide the consumables having different flavors, different color and different functions, so as to meet the user's requirements. In addition, in combination with a corresponding switching control program, it is able to customize a consumable extrusion sequence according to the user needs, so as to meet the user's requirement on personal care.

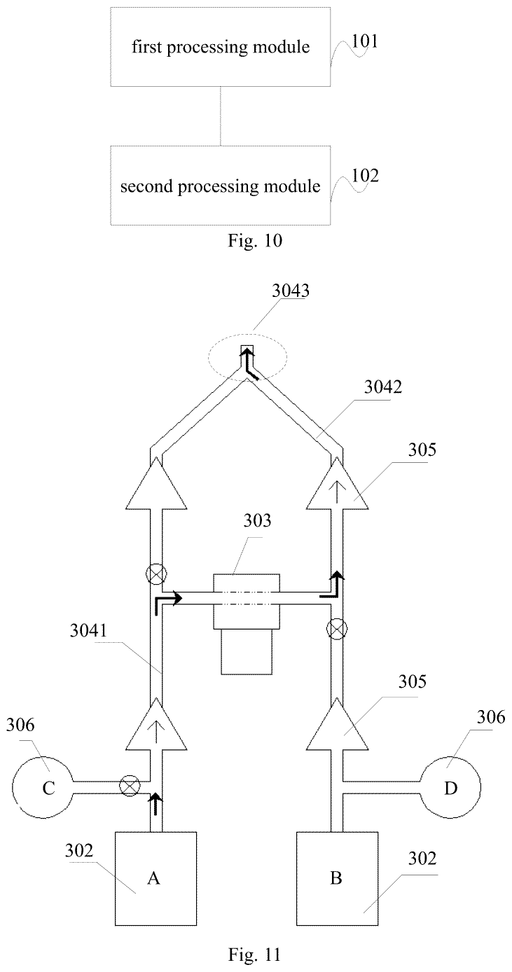

As shown in FIG. 10, the present disclosure further provides in some embodiments a consumable extrusion control device applied to the above-mentioned consumable extrusion control method, which includes: a first processing module 101 configured to apply a first signal to a first driving assembly, so that the first driving assembly is in a first driving state; and a second processing module 102 configured to apply a second signal to the first driving assembly, so that the first driving assembly is in a second driving state.

Optionally, the consumable extrusion control device further includes: a first control module configured to control the first driving assembly in the first driving state to rotate in a forward direction for a first predetermined duration in accordance with the first signal; and a second control module configured to control the first driving assembly in the second driving state to rotate in a backward direction for a second predetermined duration in accordance with the second signal. The first predetermined duration and the second predetermined duration are determined in accordance with a predetermined factor, and the predetermined factor includes at least one of: a target amount of consumable extruded from one consumable chamber in the at least two consumable chambers, diameters and lengths of the primary pipeline and the branch pipelines, or a rotation speed of the rotary pump.

Optionally, the consumable extrusion control device further includes: a first obtaining module configured to, in the case that the rotary pump rotates in a forward direction, obtain a target consumable delivery amount detected by the flow sensor on the primary pipeline; a third processing module configured to, in the case that the target consumable delivery amount meets a predetermined delivery amount, apply a third signal to the rotary pump; a fourth processing module configured to enable the rotary pump to stop rotating in the forward direction and control the rotary pump to rotate in a backward direction in accordance with the third signal; and a fifth processing module configured to, in the case that the rotary pump rotates in the backward direction and the amount of the consumable drawn from the pipeline and detected by the flow sensor is zero, enabling the rotary pump to stop rotating in the backward direction.

Optionally, the consumable extrusion control device further includes: a sixth processing module configured to apply a fourth signal to the air pump assembly, to enable a first electromagnetic valve and a third electromagnetic valve of the air pump assembly to be in an on state, and a second electromagnetic valve and a fourth electromagnetic valve of the air pump assembly to be in an off state; or a seventh processing module configured to apply a fifth signal to the first driving assembly, to enable the first electromagnetic valve and the third electromagnetic valve of the air pump to be in the off state, and the second electromagnetic valve and the fourth electromagnetic valve of the air pump are in the on state. The fourth signal is used to control the first driving assembly to be in the first driving state, and the fifth signal is used to control the first driving assembly to be in the second driving state.

The consumable extrusion control device in the embodiments of the present disclosure is used to implement the above-mentioned consumable extrusion control method with a same technical effect, which will not be further elaborated here.

In addition, In view of drawbacks in the related art that the electric toothbrush cannot realize switching of multiple toothpastes, and thus have limited cleaning methods and poor usage effectiveness, an embodiment of the present disclosure further provides an electric toothbrush capable of switching among multiple toothpastes.

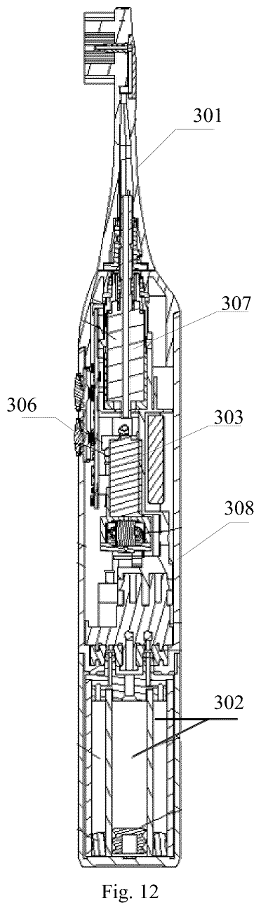

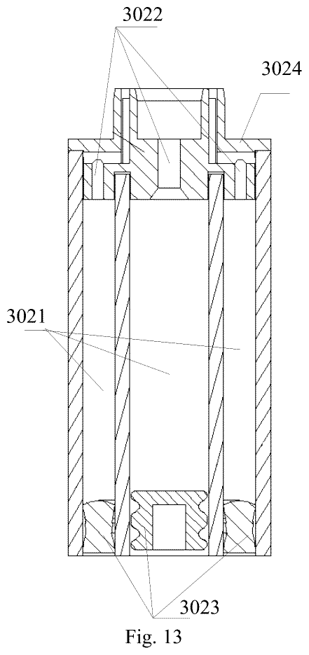

Referring to FIGS. 11 to 13, the embodiment of the present disclosure provides an electric toothbrush capable of switching among multiple toothpastes, including: a toothbrush head 301; at least two toothpaste chambers 302, each of which is connected to the toothbrush head 301 through a pipeline; a peristaltic pump 303 (first driving assembly), connected to each of the pipelines; the pipelines includes first pipelines 3041 connecting the respective toothpaste chambers to the peristaltic pump and a second pipeline 3042 connecting the peristaltic pump 303 to the toothbrush head; each of the first pipelines 3041 and the second pipeline 3042 is provided with a one-way valve structure 305; multiple electromagnetic valve assemblies 306, each of which is arranged on the respective first pipeline 3041; a control circuit, electrically connected to each of the electromagnetic valve assemblies 306 and the peristaltic pump 303.

In the embodiment of the present disclosure, one end of the peristaltic pump 303 is connected to the toothpaste chamber 302 through the first pipeline 3041, and the other end of the peristaltic pump 303 is connected to the toothbrush head 301 through the second pipeline 3042. In a possible implementation of the present disclosure, a flow direction within the pipelines is as follows: the electromagnetic valve assembly 306 (the electromagnetic valve C in FIG. 11) is controlled to be turned on, that is, the electromagnetic valve assembly 306 (the electromagnetic valve C in FIG. 11) is controlled to be energized, such that the toothpaste in the toothpaste chamber (the toothpaste chamber A in FIG. 11) is delivered to the toothbrush head by using the air pressure in the pipeline through the operation of the peristaltic pump 303. Further, after the electromagnetic valve assembly 306 (the electromagnetic valve C in FIG. 11) is controlled to be energized, the peristaltic pump 303 starts to work in forward rotation, such that a negative pressure begins to appear within the space of the toothpaste chamber A. The negative pressure may cause a piston of the toothpaste chamber A to move upward, thereby squeezing the toothpaste in the toothpaste chamber A and transmitting it upward. Due to the effect of the one-way valve structure 305, the toothpaste will flow in the direction of the arrow in FIG. 11 until it reaches an outlet, that is, a center area of bristles of the toothbrush head 301. After a period that is calculated by the control circuit for a specified weight of the toothpaste, the control circuit controls the electromagnetic valve assembly 306 to be powered off.

It should also be noted that, after being powered off, the electromagnetic valve assembly 306 allows to take in air. Since the peristaltic pump 303 is still working, the generated negative pressure will first absorb the air entering from the electromagnetic valve assembly 306, rather than absorbing the toothpaste in the toothpaste chamber A. After a calculated period from the time of absorbing air to the time when the air reaches the area of the brush head (this step is to transfer all the residual toothpaste in the pipeline to the toothbrush head 301 to avoid mixing the two toothpastes in the toothpaste chamber A and the toothpaste chamber B respectively), the peristaltic pump 303 is powered off and stops working.

Because the one-way valve structure 305 is set in the above structure, the toothpaste backflow will not occur in the pipeline.

In another possible implementation, the flow direction within the pipelines is as follows: the electromagnetic valve assembly 306 (electromagnetic valve D in FIG. 11) is controlled to be turned on, such that the toothpaste in the toothpaste chamber (toothpaste chamber B in FIG. 11) is delivered to the toothbrush head by using the air pressure in the pipeline through the operation of the peristaltic pump 303.

It should be noted that, since the electromagnetic valve assemblies 306 are arranged at the first pipelines, after any electromagnetic valve assembly 306 is turned on, the flow direction within the corresponding pipeline is in a direction form the toothpaste chamber of the first pipeline connected to the turned-on electromagnetic valve assembly 306 toward the second pipeline connected to the first pipeline via the peristaltic pump.

In the embodiment of the present disclosure, an electric toothbrush with multiple toothpaste chambers and automatic dispensing function is provided, which can store various toothpastes for distinct scenarios (e.g., morning/evening use, gum disease situation), and maximize the effective performance of the specific toothpaste under the corresponding scenario without needing separate toothpaste bags, so as to achieve the purpose of one machine with multiple uses. A variety of toothpastes with different functions can be freely combined and switched, facilitating daily oral care, maintenance, and health, thus enhancing user experience.

Optionally, the electric toothbrush also includes: a third pipeline 3043, wherein a plurality of the second pipelines 3042 are connected to an end of the third pipeline 3043, and the other end of the third pipeline 3043 is connected to the toothbrush head 301.

In this embodiment, a plurality of second pipelines 3042 are connected to an end of the third pipeline 3043, and the other end of the third pipeline 3043 is connected to the toothbrush head 301, which can save the layout space of the internal pipelines of the electric toothbrush.

It should be noted that, through the negative pressure of the pipeline, the one-way valve structure 305 and the peristaltic pump 303 may push all the remaining toothpaste within the first pipelines 3041, the second pipelines 3042 and the third pipeline 3043 to the toothbrush head 301, which can prevent the toothpaste from remaining in the third pipeline 3043, resulting in the mixing of different types of toothpastes when it switches between the toothpaste chambers 302.

Optionally, the electromagnetic valve assembly 306 is a normally-on electromagnetic valve, and when the normally-on electromagnetic valve is pressed, the control circuit sends a first pump control signal to the peristaltic pump; the first pump control signal is used to instruct the peristaltic pump to start working; when the normally-on electromagnetic valve is released, the control circuit sends a second pump control signal to the peristaltic pump; the second pump control signal is used to instruct the peristaltic pump to stop working after maintaining the working state of the peristaltic pump for a preset period.

Here, the electromagnetic valve assembly 306 is a normally-on electromagnetic valve. As shown in FIG. 11, in a possible implementation, after the electromagnetic valve assembly 306 (the electromagnetic valve C in FIG. 11) is powered on and closed, the toothpaste in the toothpaste chamber A connected to the electromagnetic valve assembly 306 (the electromagnetic valve C in FIG. 11) can be passed through. When the electromagnetic valve assembly 306 (the electromagnetic valve C in FIG. 11) is pressed, the electromagnetic valve assembly 306 (the electromagnetic valve C in FIG. 11) is powered on, and the control circuit sends a first pump control signal to the peristaltic pump 303; the first pump control signal is used to instruct the peristaltic pump 303 to start working; after a present amount of the toothpaste has been delivered, the electromagnetic valve assembly 306 (the electromagnetic valve C in FIG. 11) is powered off, and the control circuit sends a second pump control signal to the peristaltic pump 303; the second pump control signal is used to instruct the peristaltic pump 303 to stop working after maintaining the working state for a preset period.

For example, after the electromagnetic valve assembly 306 (the electromagnetic valve C in FIG. 11) is powered on and a preset amount of toothpaste is delivered to the toothbrush head 301, the electromagnetic valve assembly 306 (electromagnetic valve C in FIG. 11) is powered off, and the peristaltic pump 303 works for a few seconds to deliver the toothpaste remaining in the pipeline to the toothbrush head 301, and then the peristaltic pump 303 stops working.

Referring to FIG. 11 to FIG. 13, the toothpaste chamber 302 includes: a chamber body 3021, which is formed as a hollow structure and has a storage space for accommodating the toothpaste; a liquid outlet 3022, through which the toothpaste chamber 302 is connected to the corresponding first pipeline 3041; a piston 3023, which is arranged in the chamber body 3021 at a side distal to the liquid outlet 3022, and is in contact with an inner wall of the storage space.

In this embodiment, the piston 3023 functions as a pushing element for realizing automatic liquid discharge. The piston 3023 moves within the chamber body 3021, so that the toothpaste flows out of the chamber body 3021 and flows into the first pipeline 3041 corresponding to the chamber body 3021 through the liquid outlet 3022. The chamber body 3021 of each toothpaste chamber 302 accommodates a type of toothpaste, and different toothpaste chambers 302 may accommodate respective toothpastes with different formulas and effects.

Optionally, the chamber bodies of at least two of the toothpaste chambers 302 belong to a same center structure.

Optionally, the electric toothbrush further includes: a cover sealing structure 3024, through which the at least two toothpaste chambers 302 are sealed; the cover sealing structure 3024 includes: multiple preset pipelines; the preset pipeline can also be understood as a connecting hole arranged on the cover sealing structure 3024, which is used to connect to the corresponding first pipeline 3041; an end of each preset pipeline is connected to a respective one of the toothpaste chambers 302, and the other end of the preset pipeline is connected with the first pipeline 3041.

In this embodiment, different toothpaste chambers 302 are jointly constructed to form a toothpaste bottle through the cover sealing structure 3024, and at least two toothpaste chambers 302 are sealed through the cover sealing structure 3024, and the connection with the toothbrush handle can be achieved through the cover sealing structure 3024. When the toothpaste chamber needs to be replaced, the cover sealing structure 3024 can be disassembled to replace the single toothpaste chamber 302, without the need to disassemble the entire electric toothbrush every time the toothpaste chamber needs to be replaced.

When there are two toothpaste chambers, different toothpaste chambers 302 are assembled through the cover sealing structure 3024, and the cover sealing structure 3024 has a central opening in the center that connects to one of the toothpaste chambers, and also has a peripheral opening that connects to the other toothpaste chamber. Two toothpastes with different formulas and effects are placed in the corresponding two toothpaste chambers respectively, and the corresponding toothpaste can be actively selected for use through the control of the toothbrush body.

Optionally, the cross-sections of the multiple toothpaste chambers 302 are concentric to form a circle, and the cross-sectional shape of at least one toothpaste chamber 302 is one of a circle, a fan, a rectangle, a regular polygonal structure, and a custom pattern.

It should be noted that since the internal pipeline of the toothpaste chamber 302 is a straight pipeline, the cross-sectional shapes of the toothpaste chambers 302 are different, and the corresponding storage spaces for storing toothpastes are different.

The cross-sectional shapes of the toothpaste chambers 302 are set to be different shapes or patterns to meet the storage needs of toothpastes with different requirements. For example, according to the needs of toothpaste usages, toothpastes of different usage levels can be determined, such as toothpastes of the first usage level to the third usage level. The priority of the usage needs decreases in sequence. Then, according to different usage levels, different cross-sectional shapes of the toothpaste chambers 302 can be set, so as to store toothpastes of different capacities and different types.

Optionally, the electric toothbrush also includes: an acoustic vibration component 307, which is connected to the toothbrush head 301 and electrically connected to the control circuit.

The acoustic vibration component 307 is preferably an acoustic vibration motor, through which the purpose of vibrating and brushing teeth with the electric toothbrush can be achieved.

Optionally, the above-mentioned electric toothbrush also includes: a toothbrush handle 308; a plurality of toothpaste chambers 302 are accommodated in the toothbrush handle 308, and are arranged at a side distal to the toothbrush head 301, and the toothbrush handle 308 is connected to the toothbrush head 301.

In this embodiment, multiple toothpaste chambers 302 are placed in the toothbrush handle 308 and are arranged at the side distal to the toothbrush head 301, which is conducive to the arrangement of the internal components of the toothbrush handle 308, and it is more convenient to replace the toothpaste chamber, which conforms to the usage habits of users.

In summary, in the embodiments of the present application, the turning one/off of the electromagnetic valve assembly is controlled, and the purpose of delivering the toothpaste in the toothpaste chamber to the toothbrush head is achieved by the peristaltic pump using the air pressure in the pipeline, and the one-way valve structure is provided, so there will be no residual toothpaste in the pipeline. In the embodiments of the present disclosure, the electric toothbrush is provided with multiple toothpaste chambers and automatic liquid discharge function, which can store different toothpastes and is suitable for different scenarios. It can maximize the effect of the corresponding functional toothpaste in the applicable scenario, and there is no need to carry separated toothpaste bags, which improves the user experience.

The above embodiments are for illustrative purposes only. Obviously, a person skilled in the art may make further modifications and improvements without departing from the spirit of the present disclosure, and these modifications and improvements shall also fall within the scope of the present disclosure.

1. A consumable extrusion control system, comprising:
a main body;
a plurality consumable chambers coupled to the main body through respective pipelines;
a plurality of first driving assemblies arranged on the respective pipelines for the consumable chambers, and configured to provide a driving force for consumables in the consumable chambers; and
a control unit arranged at the main body, and configured to control and switch a corresponding first driving assembly to operate, to deliver the consumable from a corresponding consumable chamber to the main body.

2. The consumable extrusion control system according to claim 1, wherein the first driving assembly comprises a first driving state and a second driving state, wherein the first driving assembly is configured to deliver, in the first driving state, the consumable from a target consumable chamber to the main body through a corresponding pipeline, and configured to move, in the second driving state, the consumable remaining in the pipeline back into the corresponding consumable chamber.

3. The consumable extrusion control system according to claim 1, wherein the pipelines comprise a primary pipeline coupled to the main body and a plurality of branch pipelines, the branch pipelines couple the respective consumable chambers to the primary pipeline; the plurality of first driving assemblies is arranged on the corresponding branch pipelines, respectively; the first driving assembly is any one of a peristaltic pump, an air pump, a gear pump, a screw pump or a rotor pump.

4. A consumable extrusion control system, comprising:
a main body;
a plurality consumable chambers coupled to the main body through respective pipelines;
a first driving assembly coupled to the pipelines, and configured to provide a driving force for consumables in the consumable chambers;
a consumable switching assembly configured to control a corresponding pipeline to be switched between an open state and a closed state; and
a control unit arranged at the main body, and configured to control the consumable switching assembly and the first driving assembly to operate, to switch to deliver the consumable from a corresponding consumable chamber to the main body.

5. The consumable extrusion control system according to claim 4, wherein the first driving assembly comprises a first driving state and a second driving state, wherein the first driving assembly is configured to deliver, in the first driving state, the consumable from a target consumable chamber to the main body through a corresponding pipeline, and configured to move, in the second driving state, the consumable remaining in the pipeline back into the corresponding consumable chamber.

6. The consumable extrusion control system according to claim 4, wherein the consumable switching assembly comprises:
a second driving assembly and a diverter rotary disk, wherein the diverter rotary disk is coupled to the second driving assembly and adapted to the plurality of consumable chambers,
wherein the diverter rotary disk is arranged on the pipeline and provided with an opening through which the pipeline is in connection with the corresponding consumable chamber;
the second driving assembly is configured to drive the diverter rotary disk to rotate, to enable a corresponding consumable chamber to be in connection with the pipeline through the opening of the diverter rotary disk.

7. The consumable extrusion control system according to claim 6, wherein the consumable switching assembly further comprises:
a locking member coupled to the diverter rotary disk and configured to control the diverter rotary disk to be switched between a locking state and an unlocking state.

8. The consumable extrusion control system according to claim 4, wherein the pipelines comprise a primary pipeline coupled to the main body and a plurality of branch pipelines, the branch pipelines couple the respective consumable chambers to the primary pipeline;
the first driving assembly comprises two pump heads arranged on the respective branch pipelines, a rotating shaft coupled to the two pump heads and configured to drive the two pump heads, and a first spinning motor coupled to the rotating shaft, the consumable switching assembly comprises a second spinning motor coupled to the rotating shaft, the second spinning motor is configured to control and switch the rotating shaft to be coupled to or decoupled from a corresponding one of the two pump heads, and the first spinning motor is configured to drive the corresponding pump head to operate through the rotating shaft, to deliver the consumable in a corresponding branch pipeline.

9. (canceled)

10. The consumable extrusion control system according to claim 4, wherein the pipelines comprise a primary pipeline coupled to the main body and a plurality of branch pipelines, the branch pipelines couple the respective consumable chambers to the primary pipeline, the consumable switching assembly comprises:
a cam structure comprising a driving motor and a cam rotatably coupled to the driving motor,
wherein the consumable switching assembly is configured to drive the cam to be switched between a first driving position and a second driving position through the driving motor, to control the consumable chamber to switched between a state where the consumable chamber is coupled to the corresponding branch pipeline and a state where the consumable chamber is decoupled from the corresponding branch pipeline.

11. The consumable extrusion control system according to claim 4, wherein the pipelines comprise a primary pipeline coupled to the main body and a plurality of branch pipelines, the branch pipelines couple the respective consumable chambers to the primary pipeline; the consumable switching assembly is a controllable multi-way valve,
wherein the controllable multi-way valve comprises one first connection port and at least two second connection ports, the first connection port is in connection with the primary pipeline, the second connection ports are in connection with the branch pipelines respectively; the controllable multi-way valve comprises a first connection state and a first non-connection state, the controllable multi-way valve is configured to, in the first connection state, couple the primary pipeline to any one of the branch pipelines, and configured to, in the first non-connection state, decouple the primary pipeline from any one of the branch pipelines, and the control unit is further configured to control the controllable multi-way valve to be switched between the first connection state and the first non-connection state,
wherein the controllable multi-way valve is at least one of a controllable three-way valve, a two-position three-way electromagnetic valve, or a micro screw piston switch.

12. (canceled)

13. The consumable extrusion control system according to claim 8, wherein the first driving assembly is arranged on the primary pipeline, or a respective one first driving assembly is arranged on each of the branch pipelines; or the first driving assembly is coupled to the plurality of consumable chambers, wherein the first driving assembly is any one of a peristaltic pump, an air pump, a gear pump, a screw pump or a rotor pump.

14. The consumable extrusion control system according to claim 13, wherein the first driving assembly is coupled to the plurality of consumable chambers through a first common pipeline, and the first driving assembly is an air pump assembly,
wherein the air pump assembly comprises:
a second common pipeline coupled to the first common pipeline;
a third common pipeline coupled to the second common pipeline;
a fourth pipeline and a fifth pipeline coupled to two ends of the third common pipeline respectively;
an air pump assembly comprising an air inlet and an air outlet coupled to the fourth pipeline and the fifth pipeline respectively; and
an electromagnetic valve assembly comprising a first electromagnetic valve and a fourth electromagnetic valve arranged on the third common pipeline, a third electromagnetic valve arranged on the fourth pipeline and a second electromagnetic valve arranged on the fifth pipeline, wherein the first electromagnetic valve, the second electromagnetic valve, the third electromagnetic valve and the fourth electromagnetic valve are normally-on electromagnetic valves or normally-off electromagnetic valves;
the control unit is further configured to selectively control on states or off states of the first electromagnetic valve, the second electromagnetic valve, the third electromagnetic valve and the fourth electromagnetic valve of the electromagnetic valve assembly in accordance with a first driving state and a second driving state of the air pump assembly.

15. The consumable extrusion control system according to claim 14, wherein the plurality of consumable chambers is respective consumable bottles or arranged in one consumable bottle, a cross section of the consumable bottle is of a circular or polygonal shape, and a cross section of the consumable chamber is of a circular shape, a rectangular shape or a customized pattern;
wherein the consumable extrusion control system further comprises a flow sensor arranged on the pipeline, wherein the control unit is configured to control the first driving assembly to be switched between the first driving state and the second driving state in accordance with a detention result of the flow sensor.

16. (canceled)

17. A consumable extrusion control method applied to the consumable extrusion control system according to claim 1, comprising:
applying a first signal to the first driving assembly, to enable the first driving assembly to be switched to a first driving state; and
applying a second signal to the first driving assembly, to enable the first driving assembly to be switched to a second driving state.

18. The consumable extrusion control method according to claim 17, wherein the first driving assembly is a rotary pump, the consumable extrusion control method further comprises:
controlling the first driving assembly in the first driving state to rotate in a forward direction for a first predetermined duration in accordance with the first signal; and
controlling the first driving assembly in the second driving state to rotate in a backward direction for a second predetermined duration in accordance with the second signal;
wherein the first predetermined duration and the second predetermined duration are determined in accordance with a predetermined factor, and the predetermined factor comprises at least one of:
a target amount of consumable extruded from one consumable chamber in the plurality of consumable chambers;
diameters and lengths of the primary pipeline and the branch pipelines; or
a rotation speed of the rotary pump.

19. The consumable extrusion control method according to claim 17, wherein the first driving assembly is a rotary pump, the consumable extrusion control method further comprises:
in the case that the rotary pump rotates in a forward direction, obtaining a target consumable delivery amount detected by the flow sensor on the primary pipeline;
in the case that the target consumable delivery amount meets a predetermined delivery amount, applying a third signal to the rotary pump;
enabling the rotary pump to stop rotating in the forward direction and controlling the rotary pump to be switched to rotate in a backward direction in accordance with the third signal; and
in the case that the rotary pump rotates in the backward direction and the amount of the consumable drawn from the pipeline and detected by the flow sensor is zero, enabling the rotary pump to stop rotating in the backward direction.

20. The consumable extrusion control method according to claim 17, wherein the first driving assembly is an air pump assembly, the consumable extrusion control method further comprises:
applying a fourth signal to the air pump assembly, to enable a first electromagnetic valve and a third electromagnetic valve of the air pump assembly to be in an on state, and enable a second electromagnetic valve and a fourth electromagnetic valve of the air pump assembly to be in an off state; or
applying a fifth signal to the first driving assembly, to enable the first electromagnetic valve and the third electromagnetic valve of the air pump assembly to be in the off state, and enable the second electromagnetic valve and the fourth electromagnetic valve of the air pump assembly to be in the on state;
wherein the fourth signal is used to control the first driving assembly to be in a first driving state, and the fifth signal is used to control the first driving assembly to be in a second driving state.

21. A consumable extrusion control device applied to the consumable extrusion control method according to claim 17, comprising:
a first processing module configured to apply a first signal to the first driving assembly, to enable the first driving assembly to be in a first driving state; and
a second processing module configured to apply a second signal to the first driving assembly, to enable the first driving assembly to be in a second driving state.

22. An electric toothbrush capable of switching between multiple toothpastes, comprising:
a toothbrush head;
at least two toothpaste chambers, each of which being in connection with the toothbrush head through a respective pipeline;
a first driving assembly, which is in connection with each of the pipelines, wherein the pipelines comprises first pipelines and second pipelines, the first pipe lines connects the respective toothpaste chambers to the first driving assembly, and the second pipelines connect the first driving assembly to the toothbrush head; each of the first pipelines and the second pipelines is provided with a respective one-way valve structure.

23. The electric toothbrush capable of switching between the multiple toothpastes according to claim 22, wherein the first driving assembly is configured to deliver a toothpaste of a first one of the at least two toothpaste chambers to the toothbrush head when the first driving assembly rotates in a forward direction, and deliver a toothpaste of a second one of the at least two toothpaste chambers to the toothbrush head when the first driving assembly rotates in a backward direction.

24. The electric toothbrush capable of switching between the multiple toothpastes according to claim 22, further comprising:
a third pipeline, wherein the second pipelines are in connection with one end of the third pipeline, and the other end of the third pipeline is in connection with the toothbrush head.

25. The electric toothbrush capable of switching between the multiple toothpastes according to claim 22, wherein the first driving assembly is a peristaltic pump; the electric toothbrush further comprises electromagnetic valve assemblies, and a control circuit electrically connected to each of the electromagnetic valve assemblies and the peristaltic pump; each of the electromagnetic valve assemblies is arranged on the respective first pipeline; the electromagnetic valve assembly is a normally-on electromagnetic valve;
the control circuit is configured to send a first pump control signal to the peristaltic pump when the normally-on electromagnetic valve is pressed, and the first pump control signal is used to instruct the peristaltic pump to start working;
the control circuit is configured to send a second pump control signal to the peristaltic pump when the normally-on electromagnetic valve is released, and the second pump control signal is used to instruct the peristaltic pump to stop working after the peristaltic pump maintains working for a preset period.

26. The electric toothbrush capable of switching between the multiple toothpastes according to claim 22, wherein the toothpaste chamber comprises:
a chamber body, which is formed as a hollow structure and has a storage space for accommodating the toothpastes;
a liquid outlet, through which the toothpaste chamber is in connection with a corresponding one of the first pipelines;
a piston, which is arranged in the chamber body at a side distal to the liquid outlet, and is in contact with an inner wall of the storage space.

27. The electric toothbrush capable of switching between the multiple toothpastes according to claim 22, further comprising:
an acoustic vibration component, which is in connection with the toothbrush head;
a toothbrush handle;
wherein the toothpaste chambers are accommodated in the toothbrush handle, and are arranged at a side distal to the toothbrush head, and the toothbrush handle is in connection with the toothbrush head.
